(19) United States
(12) Patent Application Publication
(10) Pub. No.: US 2019/0295754 A1
(43) Pub. Date: Sep. 26, 2019

(54) R-T-B-BASED SINTERED MAGNET

(71) Applicant: TDK Corporation, Tokyo (JP)

(72) Inventors: Hikaru KUDO, Tokyo (JP); Masashi MIWA, Tokyo (JP)

(73) Assignee: TDK Corporation, Tokyo (JP)

(21) Appl. No.: 16/360,327

(22) Filed: Mar. 21, 2019

(30) Foreign Application Priority Data
Mar. 23, 2018 (JP) 2018-056590

(51) Int. Cl. H01F 1/057

(52) U.S. Cl. CPC H01F 1/0577; C22C 38/005

(57) ABSTRACT

A sintered magnet contains a rare earth element R (Nd), a transition metal element T (Fe), and B, Cu, and Ga, the sintered magnet includes a plurality of main phase grains (R₂T₁₄B crystal grains) and a plurality of grain boundary multiple junctions surrounded by three or more main phase grains, the plurality of grain boundary multiple junctions are classified into a transition metal rich phase (for example, R₆T₁₃Ga) and an R-rich phase, the R-rich phase is classified into a Cu-poor phase and a Cu-rich phase, and the following Formulas 1 and 2 are satisfied in a cross section of the sintered magnet. N1 is the number of transition metal rich phases, N2 is the number of Cu-poor phases, and N3 is the number of Cu-rich phases.

0.30≤N1/(N1+N2+N3)≤0.60 (1)

0.03≤N3/N2≤0.20 (2)

### TECHNICAL FIELD

The present invention relates to an R-T-B-based sintered magnet containing at least a rare earth element (R), a transition metal element (T), and boron (B).

### BACKGROUND

Since R-T-B-based sintered magnets have excellent magnetic properties, the R-T-B-based sintered magnets are used for motors, actuators, or the like mounted on hybrid vehicles, electric vehicles, electronic devices, home appliances, and the like. The R-T-B-based sintered magnets used for motors and the like are required to have a high coercivity even under a high temperature environment.

As a technique for improving the coercivity (HcJ) of the R-T-B-based sintered magnet at a high temperature, techniques of improving a magnetic anisotropy of an R₂T₁₄B phase by substituting a part of light rare earth elements (Nd or Pr) constituting the R₂T₁₄B phase into heavy rare earth elements (Dy or Tb) have been known. In recent years, demand for high coercive type R-T-B-based sintered magnets requiring a large amount of heavy rare earth elements is rapidly expanding.

However, the heavy rare earth elements as resources are unevenly distributed in specific countries and the output of the heavy rare earth elements is limited. Therefore, the heavy rare earth elements are more expensive than the light rare earth elements, and the supply amount of the heavy rare earth elements are not stable. For this reason, the R-T-B-based sintered magnet having a high coercivity at a high temperature even when the content of the heavy rare earth elements is small has been required.

For example, the following Pamphlet of International Publication WO 2004/081954 discloses that a ratio of B in the R-T-B-based sintered magnet is lower than a stoichiometric ratio to suppress a formation of a B-rich phase (R_{1.1}Fe₄B₄), thereby improving a residual magnetic flux density (Br) and Ga is added to the sintered magnet to suppress a formation of a soft magnetic phase (R₂Fe₁₇ phase), thereby suppressing a decrease in coercivity.

Further, the following Japanese Unexamined Patent Publication No. 2009-260338 discloses that a ratio of B in the R-T-B-based sintered magnet is lower than a stoichiometric ratio and elements such as Zr, Ga, and Si are added to the sintered magnet to increase Br and suppressing variations in magnetic properties.

### SUMMARY

However, it has been difficult to achieve the sufficiently high coercivity under a high temperature environment in which an in-vehicle drive motor or the like is exposed when the content of the heavy rare earth elements in the R-T-B-based sintered magnet is small.

An object of the present invention is to provide an R-T-B-based sintered magnet having a high coercivity and a residual magnetic flux density at a room temperature and having a high coercivity even at a high temperature, even when the content of heavy rare earth elements in the R-T-B-based sintered magnet is small.

An R-T-B-based sintered magnet according to an aspect of the present invention includes a rare earth element R, a transition metal element T, B, Cu, and Ga, in which the R-T-B-based sintered magnet contains at least one of Nd and Pr as R, the R-T-B-based sintered magnet contains at least Fe of Fe and Co as T, the R-T-B-based sintered magnet includes a plurality of main phase grains including a crystal of R₂T₁₄B and a plurality of grain boundary multiple junctions which are grain boundary phases surrounded by at least three main phase grains, the plurality of grain boundary multiple junctions are classified into at least two phases of a transition metal rich phase and an R-rich phase, the R-rich phase is classified into at least two phases of a Cu-poor phase and a Cu-rich phase, the transition metal rich phase contains R, T, and Ga, and is a phase satisfying the following Formula T1, the R-rich phase is a phase satisfying the following Formulas R1 and R2, the Cu-poor phase is a phase satisfying the following Formula C1, the Cu-rich phase is a phase satisfying the following Formula C2, the transition metal rich phase, the Cu-poor phase, and the Cu-rich phase satisfy the following Formula 1, and the Cu-poor phase and the Cu-rich phase satisfy the following Formula 2.

1.50≤([Fe]+[Co])/[R]≤3.00 (T1)

0.00≤([Fe]+[Co])/[R]<1.50 (R1)

0.00≤[O]/[R]<0.35 (R2)

0.00≤[Cu]/[R]<0.25 (C1)

0.25≤[Cu]/[R]≤1.00 (C2)

[[Fe] in the above Formula T1 and the Formula R1 is a concentration of Fe at the grain boundary multiple junction, [Co] in the above Formula T1 and the above Formula R1 is a concentration of Co at the grain boundary multiple junction, [R] in the above Formula T1, the above Formula R1, the above Formula R2, the above Formula C1, and the above Formula C2 is a concentration of R at the grain boundary multiple junction, [O] in the above Formula R2 is a concentration of O at the grain boundary multiple junction, [Cu] in the above Formula C1 and the above Formula C2 is a concentration of Cu at the grain boundary multiple junction, and units of [Fe], [Co], [R], [O], and [Cu] are each atom %.]

0.30≤N1/(N1+N2+N3)≤0.60 (1)

0.03≤N3/N2≤0.20 (2)

[N1 in the above Formula 1 is the number of transition metal rich phases of the plurality of grain boundary multiple junctions on a cross section of the R-T-B-based sintered magnet, and N2 in the above Formulas 1 and 2 is the number of Cu-poor phases of the plurality of grain boundary multiple junctions on the cross section of the R-T-B-based sintered magnet, and N3 in the above Formulas 1 and 2 is the number of Cu-rich phases of the plurality of grain boundary multiple junctions on the cross section of the R-T-B-based sintered magnet.]

The R-T-B-based sintered magnet may further include a plurality of two-grain boundaries which are grain boundary phases positioned between the two adjacent main phase grains, and at least a part of the two-grain boundaries includes at least one of the transition metal rich phase and the R-rich phase.

The R-T-B-based sintered magnet may consist of: the following elements: 29.50 to 33.00 mass % of R; 0.70 to 0.95 mass % of B, 0.03 to 0.60 mass % of Al; 0.01 to 1.50 mass % of Cu; 0.00 to 3.00 mass % of Co; 0.10 to 1.00 mass % of Ga; 0.05 to 0.30 mass % of C; 0.03 to 0.40 mass % of O; and a balance, and the balance may be Fe alone or Fe and other elements.

In the R-T-B-based sintered magnet, a total content of heavy rare earth elements may be 0.00 mass % or more and 1.00 mass % or less.

According to the present invention, it is possible to provide the R-T-B-based sintered magnet having the high coercivity and the residual magnetic flux density at a room temperature and having the high coercivity even at a high temperature, even when the content of heavy rare earth elements in the R-T-B-based sintered magnet is small.

### BRIEF DESCRIPTION OF THE DRAWINGS

FIG. 1A is a schematic perspective view of an R-T-B-based sintered magnet according to an embodiment of the present invention, and FIG. 1B is a schematic view (viewed in a direction of arrow b-b) of a cross section of the R-T-B-based sintered magnet shown in FIG. 1A;

FIG. 2 is a schematic enlarged view of a part (region II) of the cross section of the R-T-B-based sintered magnet shown in FIG. 1B;

FIG. 3 is a schematic diagram showing a sintering step and an aging treatment step included in a method of manufacturing the R-T-B-based sintered magnet according to the embodiment of the present invention; and

FIG. 4 is an image (a cross section taken by a scanning electron microscope) of a part of the cross section of the R-T-B-based sintered magnet of Example 2-3 of the present invention.

### DETAILED DESCRIPTION

Hereinafter, preferred embodiments of the present invention will be described with reference to the drawings. In the drawings, like components are denoted by like reference numerals. The present invention is not limited to the following embodiments. Any “sintered magnet” described below means an “R-T-B-based sintered magnet”. A “concentration” (unit: atom %) described below may be paraphrased as a “content”.

(Sintered Magnet)

The sintered magnet according to the present embodiment contains at least a rare earth element (R), a transition metal element (T), boron (B), copper (Cu), and gallium (Ga). Since the sintered magnet contains Ga, the transition metal rich phase described below is formed. The sintered magnet may contain oxygen (O).

The sintered magnet contains at least one of neodymium (Nd) and praseodymium (Pr) as a rare earth element R. The sintered magnet may contain both the Nd and the Pr. The sintered magnet may further contain another rare earth element R in addition to the Nd or the Pr. Other rare earth element R may be at least one selected from the groups consisting of scandium (Sc), yttrium (Y), lanthanum (La), cerium (Ce), samarium (Sm), europium (Eu), gadolinium (Gd), terbium (Tb), dysprosium (Dy), holmium (Ho), erbium (Er), thulium (Tm), ytterbium (Yb), and lutetium (Lu).

The sintered magnet contains at least iron (Fe) of Fe and cobalt (Co) as the transition metal element T. The sintered magnet may contain both the Fe and the Co.

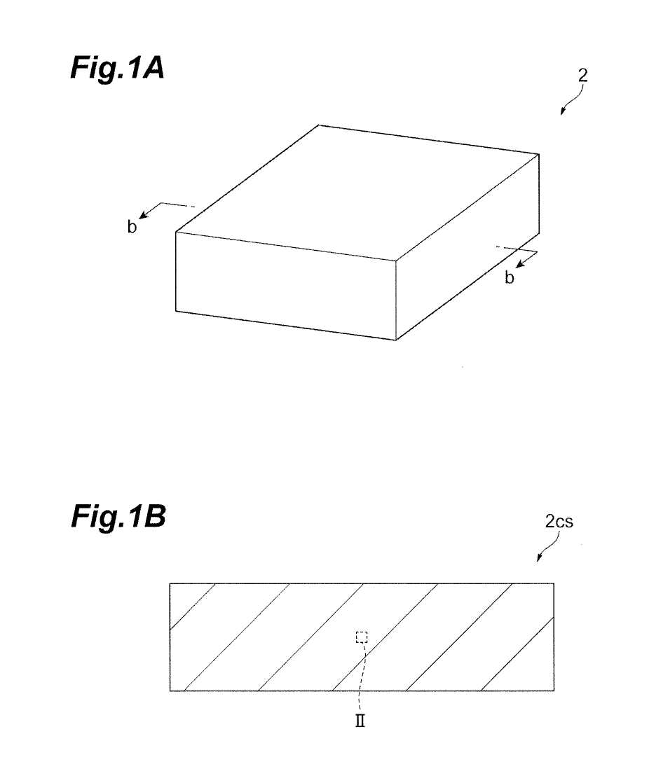

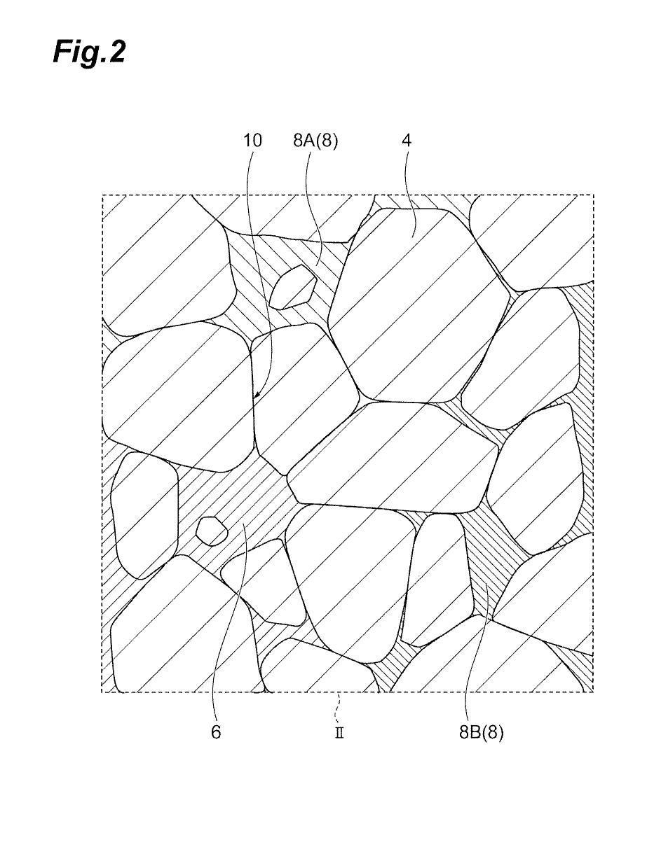

FIG. 1A is a schematic perspective view of a rectangular parallelepiped sintered magnet 2 according to the present embodiment, FIG. 1B is a schematic diagram of a cross section 2cs of the sintered magnet 2, and FIG. 2 is an enlarged view of a part (region II) of a cross section 2cs of the sintered magnet 2. A shape of the sintered magnet 2 is not limited to a rectangular parallelepiped. For example, the shape of the sintered magnet 2 may be one selected from the group consisting of an arc segment shape, a C-letter shape, a tile shape, a flat plate, a cylinder, and an arcuate shape.

As shown in FIG. 2, the sintered magnet 2 includes a plurality of (a myriad of) main phase grains 4 sintered together. The main phase grain 4 contains a crystal of R₂T₁₄B. The main phase grain 4 may consist of only a crystal (single crystal or polycrystal) of R₂T₁₄B. The main phase grain 4 may contain other elements in addition to R, T and B. A composition in the main phase grain 4 may be uniform. The composition in the main phase grain 4 may be non-uniform. For example, a concentration distribution of each of R, T and B in the main phase grain 4 may have a gradient.

The sintered magnet 2 has a plurality of grain boundary multiple junctions 6 and 8. The grain boundary multiple junctions are grain boundary phases surrounded by at least three main phase grains 4. The plurality of grain boundary multiple junctions are classified into at least two phases of a transition metal rich phase 6 and an R-rich phase 8. That is, each grain boundary multiple junction may be any of the transition metal rich phase 6 and the R-rich phase 8.

The sintered magnet 2 may also have a plurality of two-grain boundaries 10. The two-grain boundary 10 is a grain boundary phase positioned between two adjacent main phase grains 4. At least a part of the two-grain boundaries 10 may include the transition metal rich phase 6. At least a part of the two-grain boundaries 10 may include the R-rich phase 8. That is, at least a part of the two-grain boundary 10 may contain at least one of a Cu-poor phase and a Cu-rich phase which will be described later.

The transition metal rich phase 6 contains R, T, and Ga, and is a phase satisfying the following Formula T1. The transition metal rich phase 6 may be a phase containing R₆T₁₃Ga. The transition metal rich phase 6 may be a phase containing only the R₆T₁₃Ga. The R₆T₁₃Ga may be, for example, Nd₆Fe₁₃Ga. The sintered magnet 2 contains the transition metal rich phase 6, such that a coercivity of the sintered magnet 2 tends to be improved.

1.50≤([Fe]+[Co])/[R]≤3.00 (T1)

[Fe] in the above Formula T1 is a concentration of Fe at the grain boundary multiple junction, [Co] in the above Formula T1 is a concentration of Co at the grain boundary multiple junction, [R] in the above Formula T1 is a concentration of R at the grain boundary multiple junction, and units of [Fe], [Co] and [R] are each atom %.

The R-rich phase 8 contains at least R and is a phase satisfying the following Formulas R1 and R2. The R-rich phase 8 may contain only Fe of Fe and Co as the transition metal element T. The R-rich phase 8 may contain both the Fe and the Co as the transition metal element T. The R-rich phase 8 may not contain the transition metal element T. The R-rich phase 8 may contain O. The R-rich phase 8 may not contain O.

0.00≤([Fe]+[Co])/[R]<1.50 (R1)

0.00≤[O]/[R]<0.35 (R2)

[Fe] in the above Formula R1 is a concentration of Fe at the grain boundary multiple junction, [Co] in the above Formula R1 is a concentration of Co at the grain boundary multiple junction, [O] in the above Formula R2 is a concentration of O at the grain boundary multiple junction, [R] in the above Formulas R1 and R2 is a concentration of R at the grain boundary multiple junction, and units of [Fe], [Co], [O], and [R] are each atom %.

A part of the grain boundary multiple junctions may be other phases different from the transition metal rich phase 6 and the R-rich phase 8. The other phase may be, for example, a rare earth oxide phase. The rare earth oxide phase is a phase containing an oxide of R or a phase containing only an oxide of R. In the rare earth oxide phase, [O]/[R] is 0.35 or more.

The transition metal rich phase 6 and the R-rich phase 8 are quite different phases which are objectively and clearly distinguished based on a difference in composition. The transition metal rich phase 6 and the R-rich phase 8 are also distinguished based on a color contrast even in the image of the cross section 2cs of the sintered magnet 2 taken by a scanning electron microscope (SEM). There is a tendency that only one of the transition metal rich phase 6, the R-rich phase 8, and other phases exists at one grain boundary multiple junction. However, two or more of the transition metal rich phase 6, the R-rich phase 8, and other phases may exist at one grain boundary multiple junction.

The R-rich phase 8 is classified into at least two phases such as a Cu-poor phase 8A and a Cu-rich phase 8B. The R-rich phase 8 may be classified into only at least two phases such as the Cu-poor phase 8A and the Cu-rich phase 8B. That is, the Cu-poor phase 8A is one kind of the R-rich phase 8, and the Cu-rich phase 8B is another kind of the R-rich phase 8.

The Cu-poor phase 8A is a phase satisfying the following Formula C1 or C1′ among the R-rich phases 8. That is, the Cu-poor phase 8A satisfies the above-mentioned Formulas R1 and R2 and satisfies the following Formula C1. The Cu-poor phase 8A contains at least R. The Cu-poor phase 8A may contain Cu. The Cu-poor phase 8A may not contain Cu.

0.00≤[Cu]/[R]<0.25 (C1)

0.00≤[Cu]/[R]≤0.18 (C1′)

[Cu] in the above Formula C1 is a concentration of Cu at the grain boundary multiple junction, [R] in the above Formula C1 is a concentration of R at the grain boundary multiple junction, and units of [Cu] and [R] are each atom %.

The Cu-rich phase 8B is a phase satisfying the following Formula C2 among the R-rich phases 8. That is, the Cu-rich phase 8B satisfies the above-mentioned Formulas R1 and R2 and satisfies the following Formula C2. The Cu-rich phase 8B contains at least R and Cu.

0.25≤[Cu]/[R]≤1.00 (C2)

[Cu] in the above Formula C2 is a concentration of Cu at the grain boundary multiple junction, [R] in the above Formula C2 is a concentration of R at the grain boundary multiple junction, and units of [Cu] and [R] are each atom %.

The R-rich phase 8 is not arbitrarily classified into the Cu-poor phase 8A and the Cu-rich phase 8B by the present inventors. The Cu-poor phase 8A and the Cu-rich phase 8B are quite different phases which are objectively and clearly distinguished based on a difference in composition. The Cu-poor phase 8A and the Cu-rich phase 8B may be distinguished based on a color contrast even in the image of the cross section 2cs of the sintered magnet 2 taken by the scanning electron microscope (SEM). The R-rich phase 8 existing at one grain boundary multiple junction tends to be only one of the Cu-poor phase 8A and the Cu-rich phase 8B. However, both the Cu-poor phase 8A and the Cu-rich phase 8B may exist at one grain boundary multiple junction.

The transition metal rich phase 6, the Cu-poor phase 8A, and the Cu-rich phase 8B satisfy the following Formula 1, and the Cu-poor phase 8A and the Cu-rich phase 8B satisfy the following Formula 2.

0.30≤N1/(N1+N2+N3)≤0.60 (1)

0.03≤N3/N2≤0.20 (2)

N1 in the above Formula 1 is the number of transition metal rich phases 6 of the plurality of grain boundary multiple junctions on the cross section 2cs of the sintered magnet 2. N2 in the above Formulas 1 and 2 is the number of Cu-poor phases 8A of the plurality of grain boundary multiple junctions on the cross section 2cs of the sintered magnet 2. N3 in the above Formulas 1 and 2 is the number of Cu-rich phases 8B of the plurality of grain boundary multiple junctions on the cross section 2cs of the sintered magnet 2.

When N1/(N1+N2+N3) is 0.30 or more and N3/N2 is 0.03 or more and 0.20 or less, the coercivity (HcJ) of the sintered magnet 2 at a room temperature and a high temperature is improved. Further, when N1/(N1+N2+N3) is 0.60 or less, the residual magnetic flux density (Br) of the sintered magnet 2 is improved. That is, the sintered magnet 2 having the features according to the above Formulas 1 and 2 can have not only the higher residual magnetic flux density but also the higher coercivity at a room temperature and a high temperature compared with the conventional sintered magnet not having the features according to the above Formulas 1 and 2. The room temperature may be, for example, 0° C. or higher and 40° C. or lower. The high temperature may be, for example, 100° C. or higher and 200° C. or lower.

Since the sintered magnet 2 tends to have the high residual magnetic flux density and the high coercivity, the transition metal rich phase 6, the Cu-poor phase 8A, and the Cu-rich phase 8B may satisfy any of the following Formulas 1-1 to 1-14.

0.30≤N1/(N1+N2+N3)≤0.55 (1-1)

0.30≤N1/(N1+N2+N3)≤0.50 (1-2)

0.30≤N1/(N1+N2+N3)≤0.48 (1-3)

0.30≤N1/(N1+N2+N3)≤0.45 (1-4)

0.35≤N1/(N1+N2+N3)≤0.60 (1-5)

0.35≤N1/(N1+N2+N3)≤0.55 (1-6)

0.35≤N1/(N1+N2+N3)≤0.50 (1-7)

0.35≤N1/(N1+N2+N3)≤0.48 (1-8)

0.35≤N1/(N1+N2+N3)≤0.45 (1-9)

0.36≤N1/(N1+N2+N3)≤0.60 (1-10)

0.36≤N1/(N1+N2+N3)≤0.55 (1-11)

0.36≤N1/(N1+N2+N3)≤0.50 (1-12)

0.36≤N1/(N1+N2+N3)≤0.48 (1-13)

0.36≤N1/(N1+N2+N3)≤0.45 (1-14)

Since the sintered magnet 2 tends to have the high residual magnetic flux density and the high coercivity, the Cu-poor phase 8A and the Cu-rich phase 8B may satisfy any of the following Formulas 2-1 to 2-11.

0.03≤N3/N2≤0.18 (2-1)

0.03≤N3/N2≤0.12 (2-2)

0.03≤N3/N2≤0.11 (2-3)

0.04≤N3/N2≤0.20 (2-4)

0.04≤N3/N2≤0.18 (2-5)

0.04≤N3/N2≤0.12 (2-6)

0.04≤N3/N2≤0.11 (2-7)

0.10≤N3/N2≤0.20 (2-8)

0.10≤N3/N2≤0.18 (2-9)

0.10≤N3/N2≤0.12 (2-10)

0.10≤N3/N2≤0.11 (2-11)

The mechanism of making the sintered magnet 2 have the high residual magnetic flux density and the high coercivity is as follows.

Although the concentration of iron in the transition metal rich phase 6 is higher than the other grain boundary phases, a magnetization of the transition metal rich phase 6 is low. Since the transition metal rich phase 6 having a low magnetization exists between two or more adjacent main phase grains 4 (crystal grains of R₂T₁₄B) (since the transition metal rich phase 6 exists in the grain boundary multiple junction and two-grain boundary 10), a magnetic coupling between the main phase grains 4 is decoupled. That is, the crystal grains of two or more adjacent R₂T₁₄B are separated from each other by having the transition metal rich phase 6 having a low magnetization interposed therebetween. Therefore, the coercivity at a room temperature and a high temperature is improved due to at least fixed amount (amount defined in the above Formula 1) of transition metal rich phase 6 contained in the sintered magnet 2. That is, in order for the sintered magnet 2 to have the high coercivity, it is necessary to set N1/(N1+N2+N3) to be 0.30 or more.

However, if the transition metal rich phase 6 is too much, the residual magnetic flux density of the sintered magnet 2 is decreased. This is because in the manufacturing process (sintering step and aging treatment step) of the sintered magnet 2, the transition metal element T constituting the main phase grain 4 (R₂T₁₄B) is consumed for forming the transition metal rich phase 6, and a volume ratio of the main phase grain 4 in the sintered magnet is decreased. Therefore, in order for the sintered magnet 2 to have the high residual magnetic flux density, it is necessary to set N1/(N1+N2+N3) to be 0.60 or less.

In the manufacturing process (sintering step and aging treatment step) of the sintered magnet 2, the concentration of the transition metal element T (for example, Fe) in the R-rich phase 8 is decreased with the formation of the transition metal rich phase 6, such that the magnetization of the R-rich phase 8 is decreased. Since the R-rich phase 8 having a low magnetization exists between two or more adjacent main phase grains 4 (crystal grains of R₂T₁₄B) (since the R-rich phase 8 exists in the grain boundary multiple junction and two-grain boundary 10), the magnetic coupling between the main phase grains 4 is decoupled. That is, the crystal grains of two or more adjacent R₂T₁₄B are separated from each other by having the R-rich phase 8 having a low magnetization interposed therebetween. Therefore, the coercivity at a room temperature and a high temperature is improved by including the R-rich phase 8 in the sintered magnet 2.

When the sintered magnet 2 contains at least a fixed amount (the amount defined by, the above Formula 2) of Cu-rich phase 8B as the R-rich phase 8, the coercivity at a room temperature hardly changes, but the coercivity at a high temperature is improved. That is, in order for the sintered magnet 2 to have the high coercivity at a high temperature, it is necessary to set N3/N2 to be 0.03 or more. The reason is not clearly understood. The following mechanism for the Cu-rich phase 8B is a hypothesis.

The Cu-poor phase 8A and the Cu-rich phase 8B have an equivalent magnetization at a room temperature. However, the Cu-poor phase 8A and the Cu-rich phase 8B are different from each other in a temperature dependence of the magnetization. Therefore, as the temperature rises, the strength of the magnetic coupling of two or more adjacent main phase grains 4 (crystal grains of R₂T₁₄B) is changed. For example, there is a possibility that the magnetization of the Cu-rich phase 8B is decreased as the temperature rises. Since the Cu-rich phase 8B having a low magnetization exists between two or more adjacent main phase grains 4 (since the Cu-rich phase 8B exists in the grain boundary multiple junction and the two-grain boundary 10) at a high temperature, there is a possibility that the magnetic coupling between the main phase grains 4 is decoupled.

However, when the Cu-rich phase 8B is too much, the coercivity of the sintered magnet 2 at a room temperature and a high temperature is decreased. The reason is not clearly understood. In the manufacturing process (for example, an aging treatment step) of the sintered magnet 2, the Cu-rich phase 8B tends to accumulate at the grain boundary multiple junction than the Cu-poor phase 8A. As a result, it is estimated that it is difficult to fowl a thick two-grain boundary 10 and the number of places where a magnetic separation is insufficient between two or more adjacent main phase grains 4 (crystal grains of R₂T₁₄B) is increased.

The mechanism of making the sintered magnet 2 have the high residual magnetic flux density and the high coercivity is not limited to the above-described mechanism.

An average grain size of the main phase grains 4 is not particularly limited but may be, for example, 1.0 μmore and 10.0 μless. A total value of the ratio of the volume of the main phase grain 4 in the sintered magnet 2 is not particularly limited, but may be, for example, 75 vol % or more and less than 100 vol %.

The sintered magnet 2 having the technical features described above can have the sufficiently high coercivity at a high temperature even when the sintered magnet 2 does not contain heavy rare earth elements. However, in order to further increase the coercivity of the sintered magnet 2 at a high temperature, the sintered magnet 2 may contain heavy rare earth elements. However, when the content of the heavy rare earth elements is too much, the residual magnetic flux density tends to be decreased. For example, the total content of the heavy rare earth elements in the sintered magnet 2 may be 0.00 mass % or more and 1.00 mass % or less. By suppressing the use of the heavy rare earth elements as much as possible, a resource risk of using the heavy rare earth elements can be reduced. The heavy rare earth element is at least one selected from the group consisting of gadolinium (Gd), terbium (Tb), dysprosium (Dy), holmium (Ho), erbium (Er), thulium (Tm), ytterbium (Yb), and lutetium (Lu).

The compositions of the main phase grain 4, the transition metal rich phase 6, and the R-rich phase 8 (Cu-poor phase 8A and Cu-rich phase 8B) described above each may be specified by analyzing the cross section 2cs of the sintered magnet 2 using an energy dispersive X-ray spectroscopy (EDS) apparatus.

The specific composition of the entire sintered magnet 2 will be described below. However, the composition range of the sintered magnet 2 is not limited to the following. The composition of the sintered magnet 2 may be out of the following composition range as long as the effect of the present invention resulting from the above-described composition of the grain boundary phase can be obtained.

The content of R in the sintered magnet may be 29.50 to 33.00 mass %. When the sintered magnet contains a heavy rare earth element as R, the total content of all rare earth elements including the heavy rare earth elements may be 29.5 to 33 mass %. When the content of R is in this range, the high residual magnetic flux density and the high coercivity tend to be obtained. When the content of R is too small, it is difficult to form the main phase grains (R₂T₁₄B), such that an α-Fe phase having soft magnetic properties tends to be formed and the coercivity tends to be decreased. On the other hand, when the content of R is too much, the volume ratio of the main phase grains tends to be decreased and the residual magnetic flux density tends to be decreased. Since the volume ratio of the main phase grains is increased and the residual magnetic flux density tends to increase, the content of R may be 30.00 to 32.50 mass %. Since the residual magnetic flux density and the coercivity tend to be increased, the total ratio of Nd and Pr in the total rare earth element R may be 80 to 100 atom % or 95 to 100 atom %.

The content of B in the sintered magnet may be 0.70 to 0.95 mass %. When the content of B is smaller than the stoichiometric ratio of the composition of the main phase represented by R₂T₁₄B, the transition metal rich phase tends to be formed and the coercivity tends to be improved. When the content of B is too small, the R₂T₁₇ phase tends to be deposited and the coercivity tends to be decreased. On the other hand, when the content of B is too much, the transition metal rich phase is not sufficiently formed and the coercivity tends to be decreased. Since the residual magnetic flux density and the coercivity tend to be increased, the content of B may be 0.75 to 0.90 mass % or 0.80 to 0.88 mass %.

The sintered magnet may contain aluminum (Al). The content of Al in the sintered magnet may be 0.03 to 0.60 mass % or 0.03 to 0.30 mass %. When the content of Al is in the above range, the coercivity and the corrosion resistance of the sintered magnet are easily improved.

The content of Cu in the sintered magnet may be 0.01 to 1.50 mass %, 0.03 to 1.00 mass %, or 0.05 to 0.50 mass %. When the content of Cu is in the above range, the coercivity, the corrosion resistance, and the temperature characteristics of the sintered magnet are easily improved. When the content of Cu is too small, the Cu-rich phase is not sufficiently formed, and the coercivity at a high temperature tends to be decreased. On the other hand, when the content of Cu is too much, the Cu-rich phase tends to be excessively formed and the coercivity at a room temperature tends to be decreased. Since the coercivity at a room temperature and the coercivity at a high temperature tend to be increased, the content of Cu may be 0.01 to 0.50 mass %.

The content of Co in the sintered magnet may be 0.00 to 3.00 mass %. Like Fe, Co may be the transition metal element T constituting the main phase grain (crystal grain of R₂T₁₄B). The sintered magnet contains Co, such that a curie temperature of the sintered magnet tends to be improved, and the sintered magnet contains Co, such that the corrosion resistance of the grain boundary phase tends to be improved and the corrosion resistance of the entire sintered magnet tends to be improved. Since these effects tend to be obtained, the content of Co in the sintered magnet may be 0.30 to 2.50 mass %.

The content of Ga may be 0.10 to 1.00 mass % or 0.20 to 0.80 mass %. When the content of Ga is too small, the transition metal rich phase is not sufficiently formed, and the coercivity tends to be decreased. When the content of Ga is too much, the transition metal rich phase is excessively formed, the volume ratio of the main phase is decreased, and the residual magnetic flux density tends to be decreased. Since the residual magnetic flux density and the coercivity tend to be increased, the content of Ga may be 0.20 to 0.80 mass %.

The sintered magnet may contain carbon (C). The content of C in the sintered magnet may be 0.05 to 0.30 mass % or 0.10 to 0.25 mass %. When the content of C is too small, the R₂T₁₇ phase tends to be deposited and the coercivity tends to be decreased. When the content of C is too much, the transition metal rich phase is not sufficiently formed and the coercivity tends to be decreased. Since the coercivity tends to be improved, the content of C may be 0.10 to 0.25 mass %.

The content of O in the sintered magnet may be 0.03 to 0.40 mass %. When the content of O is too small, the corrosion resistance of the sintered magnet tends to be decreased, and when the content of O is too much, the coercivity tends to be decreased. Since the corrosion resistance and the coercivity tend to be increased, the content of O may be 0.05 to 0.30 mass % or 0.05 to 0.25 mass %.

The sintered magnet may also contain nitrogen (N). The content of N in the sintered magnet may be 0.00 to 0.15 mass %. When the content of N is too much, the coercivity tends to be decreased.

The balance obtained by removing the above elements from the sintered magnet may be Fe alone or Fe and other elements. In order for the sintered magnet to have sufficient magnetic properties, the total content of elements other than Fe in the balance may be 5 mass % or less with respect to the total mass of the sintered magnet.

The sintered magnet may contain, for example, zirconium (Zr) as the balance (other elements). The content of Zr in the sintered magnet may be 0.00 to 1.50 mass %, 0.03 to 0.80 mass %, or 0.10 to 0.60 mass %. Zr suppresses the abnormal grain growth of the main phase grains (crystal grains) during the manufacturing process (sintering step) of the sintered magnet and makes the structure of the sintered magnet uniform and fine, thereby making it possible to improve the magnetic properties of the sintered magnet.

The sintered magnet may contain at least one selected from the group consisting of manganese (Mn), calcium (Ca), nickel (Ni), silicon (Si), chlorine (Cl), sulfur (S), and fluorine (F) as inevitable impurities. The total value of the content of the inevitable impurities in the sintered magnet may be 0.001 to 0.50 mass %.

The composition of the entire sintered magnet may be specified by, for example, a fluorescent X-ray (XRF) analysis method, a high frequency inductively coupled plasma (ICP) emission spectrometry method, and an inert gas fusion-non-dispersive infrared absorption (NDIR) method.

The sintered magnet according to the present embodiment may be applied to a motor, an actuator or the like. For example, the sintered magnet may be used in various fields such as a hybrid vehicle, an electric vehicle, a hard disk drive, a magnetic resonance imaging (MRI) apparatus, a smartphone, a digital camera, a slim-type TV, a scanner, an air conditioner, a heat pump, a refrigerator, a vacuum cleaner, a wash dryer, an elevator, and a wind power generator.

(Method of Manufacturing Sintered Magnet)

Hereinafter, a method of manufacturing the above-described sintered magnet will be described.

A raw material alloy is prepared from a metal (raw material metal) containing each element constituting the sintered magnet by a strip casting method or the like. The raw material metal may be, for example, a simple substance of a rare earth element (metal simple substance), an alloy containing a rare earth element, pure iron, ferroboron, or an alloy containing these. These raw material metals are weighed to match the composition of the desired sintered magnet. As the raw material alloy, a plurality of alloys having different compositions may be prepared.

The raw material alloy is pulverized to prepare a raw material alloy powder. The raw material alloy may be pulverized in two steps of a coarsely pulverizing step and a finely pulverizing step. In the coarsely pulverizing step, for example, a pulverization method such as a stamp mill, a jaw crusher, a brown mill, or the like may be used. The coarsely pulverizing step may be performed under an inert gas atmosphere. After hydrogen is stored into the raw material alloy, the raw material alloy may be pulverized. That is, hydrogen storage pulverization may be performed as the coarsely pulverizing step. In the coarsely pulverizing step, the raw material alloy is pulverized until the particle size of the raw material alloy becomes about several hundred μm. In the finely pulverizing step subsequent to the coarsely pulverizing step, the raw material alloy that has undergone the coarsely pulverizing step is further pulverized until the average particle size of the raw material alloy reaches 3 to 5 μm. In the finely pulverizing step, for example, a jet mill may be used.

The raw material alloy may not be pulverized in two steps of the coarsely pulverizing step and the finely pulverizing step. For example, only the finely pulverizing step may be performed. In addition, when plural kinds of raw material alloys are used, each raw material alloy may be pulverized separately and then mixed.

The raw material alloy powder obtained by the above method is pressed in a magnetic field to obtain a green compact. For example, the raw material alloy powder is pressurized in a mold while applying a magnetic field to the material alloy powder in the mold to obtain the green compact. The pressure applied to the raw material alloy powder by the mold may be 30 to 300 MPa. The intensity of the magnetic field applied to the raw material alloy powder may be 950 to 1600 kA/m.

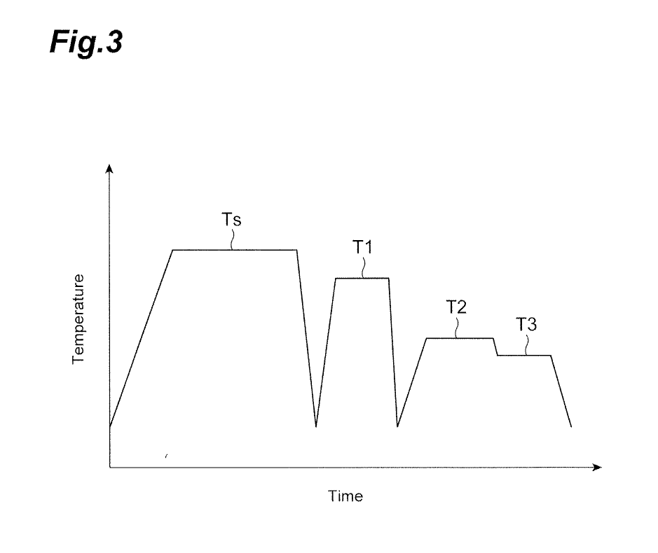

The characteristic grain boundary multiple junctions included in the sintered magnet according to the present embodiment are formed by undergoing the three-step aging treatment step subsequent to the sintering step as described below. A temperature profile of the sintering step and the aging treatment step over time is shown in FIG. 3. Details of the sintering step and the aging treatment step are as follows.

In the sintering step, the above-mentioned green compact is sintered under a vacuum or inert gas atmosphere to obtain a sintered body. The sintering conditions may be appropriately set depending on the intended composition of the sintered magnet, the pulverization method of the raw material alloy, the particle size, and the like. The sintering temperature Ts may be, for example, 1000 to 1100° C. The sintering time may be 1 to 24 hours.

The aging treatment step includes a first aging treatment, a second aging treatment subsequent to the first aging treatment, and a third aging treatment subsequent to the second aging treatment. In the three-step aging treatment step, the sintered body is heated under the vacuum or inert gas atmosphere. As shown in FIG. 3, in the first aging treatment, the sintered body is heated at a first temperature T1. In the second aging treatment, the sintered body is heated at a second temperature T2. In the third aging treatment, the sintered body is heated at a third temperature T3. The first temperature T1 is higher than the second temperature T2, and the second temperature T2 is higher than the third temperature T3. In the second aging treatment, the transition metal rich phase and the R-rich phase tend to be formed, and in the third aging treatment, the R-rich phase tends to be separated into the Cu-poor phase and the Cu-rich phase. If the first temperature T1 is lower than the second temperature T2, the Cu-rich phase is separated into the Cu-poor phase and the Cu-rich phase in the first aging treatment, and the Cu-rich phase tends to be melted and decreased in the second aging treatment. That is, the composition of the R-rich phase separated into the Cu-poor phase and the Cu-rich phase in the first aging treatment tends to return to a uniform composition again in the second aging treatment. As a result, it is difficult to satisfy the following Formulas 1 and 2. If the second temperature T2 is lower than the third temperature T3, the Cu-rich phase is separated into the Cu-poor phase and the Cu-rich phase in the second aging treatment, and the Cu-rich phase tends to be melted and decreased in the third aging treatment. That is, the composition of the R-rich phase separated into the Cu-poor phase and the Cu-rich phase in the second aging treatment tends to return to a uniform composition again in the third aging treatment. As a result, it is difficult to satisfy the following Formulas 1 and 2.

0.30≤N1/(N1+N2+N3)≤0.60 (1)

0.03≤N3/N2≤0.20 (2)

The first temperature T1 may be 700 to 1000° C. When the first temperature T1 is less than 700° C., the transition metal rich phase is not sufficiently dispersed in the second aging treatment, and a squareness ratio (Hk/HcJ) tends to be decreased. When the first temperature T1 exceeds 1000° C., the rare earth oxide phase is not sufficiently dispersed, and the squareness ratio (Hk/HcJ) tends to be decreased. Time t1 of the first aging treatment (time when the sintered body is continuously heated at the first temperature T1) may be 1 to 5 hours. When t1 is less than 1 hour, the transition metal rich phase in the second aging treatment is not sufficiently dispersed in the second aging treatment, and the squareness ratio (Hk/HcJ) tends to be decreased. When t1 exceeds 5 hours, the rare earth oxide phase is not sufficiently dispersed, and the squareness ratio (Hk/HcJ) tends to be decreased.

The second temperature T2 may be 500 to 600° C. When the second temperature T2 is lower than 500° C., the transition metal rich phase is more difficult to be formed than the Cu-poor phase and the Cu-rich phase, and N1/(N1+N2+N3) tends to be less than 0.30. When the second temperature T2 exceeds 600° C., the transition metal rich phase tends to be excessively formed as compared with the Cu-poor phase and the Cu-rich phase, and N1/(N1+N2+N3) tends to exceed 0.60. Time t2 of the second aging treatment (time when the sintered body is continuously heated at the second temperature T2) may be 1 to 5 hours. When t2 is less than 1 hour, the transition metal rich phase is not sufficiently formed, N1/(N1+N2+N3) tends to be less than 0.30, and the coercivity tends to be decreased. When t2 exceeds 5 hours, the transition metal rich phase is excessively formed, N1/(N1+N2+N3) tends to exceed 0.60 and the residual magnetic flux density tends to be decreased. If the second aging treatment is not performed, the transition metal rich phase is more difficult to be formed than the Cu-poor phase and the Cu-rich phase, and N1/(N1+N2+N3) tends to be less than 0.30.

The third temperature T3 may be 410 to 490° C. When the third temperature T3 is lower than 410° C., a liquid phase is not sufficiently generated, a reaction for forming the Cu-poor phase hardly occurs, N3/N2 tends to be less than 0.03 and the coercivity at a high temperature tends to be decreased. When the third temperature T3 exceeds 490° C., the transition metal rich phase tends to be excessively formed, N3/N2 tends to exceed 0.20, and the residual magnetic flux density and the coercivity tend to be decreased. Time t3 of the third aging treatment (time when the sintered body is continuously heated at the third temperature T3) may be 3 to 5 hours. When t3 is less than 3 hours, the Cu-rich phase is more difficult to be formed than the Cu-poor phase, and N3/N2 tends to be less than 0.03. When t3 exceeds 5 hours, the Cu-rich phase is excessively formed, such that N3/N2 tends to exceed 0.20. If the third aging treatment is not performed, the Cu-rich phase is more difficult to be formed than the Cu-poor phase, and N3/N2 tends to be less than 0.03.

As shown in FIG. 3, in the case of raising the temperature of the atmosphere from a temperature lower than Ts (for example, room temperature) to Ts in order to start the sintering step, a temperature rising rate may be 0.1 to 20° C./min. The “temperature of the atmosphere” is a temperature of the atmosphere around the sintered body, for example, a temperature in a heating furnace. After the sintering step, in the case of lowering the temperature of the atmosphere from Ts to a temperature lower than T1 (for example, room temperature), a temperature falling rate may be 1 to 50° C./min. In the case of raising the temperature of the atmosphere from a temperature lower than T1 (for example, room temperature) to T1 in order to start the first aging treatment, a temperature rising rate may be 0.1 to 20° C./min. After the first aging treatment, in the case of lowering the temperature of the atmosphere from T1 to a temperature lower than T2 (for example, room temperature), a temperature falling rate may be 1 to 50° C./min. In the case of raising the temperature of the atmosphere from a temperature lower than T2 (for example, room temperature) to T2 in order to start the second aging treatment, a temperature rising rate may be 0.1 to 50° C./min. After the first aging treatment, the temperature of the atmosphere may be lowered from T1 to T2, and the second aging treatment may be performed continuously to the first aging treatment. After the second aging treatment, when the temperature of the atmosphere of the aging treatment is lowered from T2 to T3, a temperature falling rate may be 1 to 50° C./min. After the third aging treatment, in the case of lowering the temperature of the atmosphere of the aging treatment from T3 to a temperature lower than T3 (for example, room temperature), a temperature falling rate may be 1 to 50° C./min. Since the temperature rising rate and the temperature falling rate in each of the sintering step, the first aging treatment, the second aging treatment, and the third aging treatment are within the above ranges, the above Formulas 1 and 2 are easily satisfied.

By the above-described method, the sintered magnet according to this embodiment is obtained.

In the case of manufacturing the sintered magnet containing the heavy rare earth elements, the heavy rare earth elements or compounds thereof (for example, hydride) may be attached to the surface of the sintered body and then the sintered body may be heated. By this thermal diffusion treatment, the heavy rare earth elements can diffuse inwardly from the surface of the sintered body. For example, the first aging treatment, the second aging treatment, and the third aging treatment may be performed after the thermal diffusion treatment subsequent to the sintering step. The second aging treatment and the third aging treatment may be performed after the thermal diffusion treatment is performed subsequent to the first aging treatment.

### EXAMPLE

Hereinafter, the present invention will be described in more detail with reference to examples, but the present invention is not limited by these examples at all.

### Example 1-1

[Production of Sintered Magnet]

A raw material alloy was prepared from a raw material metal of a sintered magnet by a strip casting method. A composition of a raw material alloy was adjusted by weighing the raw material metal. The content of each element in the raw material alloy was adjusted to the following values.

The content of Nd was 24.96 mass %. The content of Pr was 6.24 mass %. The content of B was 0.86 mass %. The content of Co was 2.00 mass %. The content of Cu was 0.50 mass %. The content of Ga was 1.00 mass %. The content of Al was 0.20 mass %. The content of Zr was 0.20 mass %. A balance obtained by removing the elements from the raw material alloy was Fe and a trace of inevitable impurities (Tb or the like). The content of each of Nd, Pr, Fe, Co, Ga, Al, Cu, and Zr was measured by X-ray fluorescence analysis. The content of B was measured by ICP emission spectrometry. The content of O was measured by an inert gas fusion-non-dispersive infrared absorption method.

After hydrogen was stored in the raw material alloy described above, the raw material alloy was heated at 600° C. for 1 hour under an Ar atmosphere to be dehydrogenated, thereby obtaining a raw material alloy powder. That is, hydrogen pulverizing treatment was performed. Each step from the hydrogen pulverizing treatment to the following sintering step was performed under a nonoxidizing atmosphere having an oxygen concentration of less than 100 ppm.

Oleic acid amide was added to the raw material alloy powder as a pulverization aid, and these were mixed. The content of C in the final sintered magnet was adjusted by adjusting the addition amount of oleic acid amide. In the subsequent finely pulverizing step, the average particle size of the raw material alloy powder was adjusted to 4 μm using the jet mill. In the subsequent pressing step, the raw material alloy powder was filled in a mold. Then, the raw material powder was pressurized at 120 MPa while applying a magnetic field of 1200 kA/m to the raw material powder in the mold to obtain a green compact.

In the sintering step, the green compact was heated at 1060° C. (sintering temperature Ts) for 4 hours in a vacuum and then quenched to obtain a sintered body.

As an aging treatment step, a first aging treatment, a second aging treatment subsequent to the first aging treatment, and a third aging treatment subsequent to the second aging treatment were performed. In any of the first aging treatment, the second aging treatment, and the third aging treatment, the sintered body was heated in an Ar atmosphere.

In the first aging treatment, the sintered body was heated at 900° C. (first temperature T1) for 60 minutes.

In the second aging treatment, the sintered body was heated at the second temperature T2 shown in the following Table 1. Time t2 of the second aging treatment (time when the sintered body is continuously heated at the second temperature T2) is shown in the following Table 1.

In the third aging treatment, the sintered body was heated at the third temperature T3 shown in the following Table 1. Time t3 of the third aging treatment (time when the sintered body is continuously heated at the third temperature T3) is shown in the following Table 1.

By the above-described method, the sintered magnet of Example 1-1 was obtained.

[Composition Analysis of Sintered Magnet]

As a result of analyzing the composition of the sintered magnet, the content of each element in the sintered magnet was as follows. The content of Nd was 24.80 mass %. The content of Pr was 6.20 mass %. The content of B was 0.86 mass %. The content of Co was 2.00 mass %. The content of Cu was 0.50 mass %. The content of Ga was 1.00 mass %. The content of Al was 0.20 mass %. The content of Zr was 0.20 mass %. The content of oxygen was 0.08 mass %. A balance obtained by removing the elements from the raw material alloy was Fe and a trace of inevitable impurities (Tb or the like). The content of each of Nd, Pr, Fe, Co, Ga, Al, Cu, and Zr was measured by the X-ray fluorescence analysis. The content of B was measured by the ICP emission spectrometry. The content of O was measured by the inert gas fusion-non-dispersive infrared absorption method.

[Measurement of Magnetic Properties]

A residual magnetic flux density (Br) and a coercivity (HcJ) of the sintered magnet at 23° C. (room temperature) were measured. In addition, the HcJ of the sintered magnet at 150° C. (high temperature) was measured. For measurement of Br and HcJ, a B—H tracer was used. The results of measuring the magnetic properties are shown in the following Table 1.

[Analysis of Cross Section of Sintered Magnet]

The sintered magnet was cut perpendicularly with respect to its oriented direction. The cross section of the sintered magnet was polished by ion milling to remove impurities such as oxide formed on the cross section. Subsequently, a region of a part of the cross section of the sintered magnet was analyzed with a scanning electron microscope (SEM) and an energy dispersive X-ray spectroscopy (EDS) apparatus. A dimension of the analyzed region was 100 μm×100 μm. The analyzed region was a region in which a depth from the surface of the sintered magnet exceeded 300 μm. In other words, the analyzed region was a region in which a distance from an outer edge (outer peripheral part) of the cross section in the cross section of the sintered magnet exceeded 300 μm. As the SEM, a Schottky scanning electron microscope “SU 5000” manufactured by Hitachi High-Technologies Corporation was used. As the EDS apparatus, “Energy Dispersive X-ray Analyzer EMAX Evolution/EMAX ENERGY (EMAX X-MaxN Detector Specification)” manufactured by HORIBA, Ltd. was used. The measurement conditions were set as follows. The concentration (unit: atom %) of each element described below is a value based on quantitative analysis by the EDS, and is a value when the total concentration of O, Al, Fe, Co, Cu, Ga, Nd, and Pr is 100 atom %.

Acceleration voltage: 15 kV

Spot intensity: 30

Working distance: 10 mm

As a result of the analysis, it was confirmed that the sintered magnet of Example 1-1 has the following characteristics.

The sintered magnet had a plurality of main phase grains including crystals of R₂T₁₄B and a plurality of grain boundary multiple junctions that are grain boundary phases surrounded by at least three main phase grains. T is Fe and Co.

A part of the grain boundary multiple junctions includes R₆T₁₃Ga, and was the transition metal rich phase satisfying the following Formula T1. R is Nd and Pr. T is Fe and Co.

1.50≤([Fe]+[Co])/[R]≤3.00 (T1)

[Fe] is a concentration of Fe at the grain boundary multiple junction, [Co] is a concentration of Co at the grain boundary multiple junction, [R] is a concentration of R at the grain boundary multiple junction, and units of [Fe], [Co] and [R] are each atom %.

A part of the grain boundary multiple junctions was a Cu-poor phase satisfying the following Formulas R1, R2, and C1. A part of the grain boundary multiple junctions was a Cu-rich phase satisfying the following Formulas R1, R2, and C2.

0.00≤([Fe]+[Co])/[R]<1.50 (R1)

0.00≤[O]/[R]<0.35 (R2)

0.00≤[Cu]/[R]<0.25 (C1)

0.25≤[Cu]/[R]≤1.00 (C2)

[O] is the concentration of O at the grain boundary multiple junction, [Cu] is the concentration of Cu at the grain boundary multiple junction, and units of [O] and [Cu] are each atom %.

A part of the grain boundary multiple junctions was not the transition metal rich phase, the Cu-poor phase, and the Cu-rich phase, but was a phase (rare earth oxide phase) consisting of oxide of R.

100 grain boundary multiple junctions whose dimensions were larger than 1.0 μm×1.0 μm were randomly selected from the cross section of the sintered magnet. Point analysis was performed by the EDS at each of the grain boundary multiple junctions selected. However, rare earth oxide phases are not included at the 100 grain boundary multiple junctions. Based on the results of the point analysis by the EDS, the number N1 of grain boundary multiple junctions which are the transition metal rich phase, the number N2 of grain boundary multiple junctions which is the Cu-poor phase, and the number N3 of grain boundary multiple junctions which is the Cu-rich phase were counted. The sum of N1, N2, and N3 is 100. Subsequently, the values of N1/(N1+N2+N3) and N3/N2 were calculated. N1/(N1+N2+N3) and N3/N2 of Example 1-1 are shown in the following Table 1.

### Examples 1-2, 1-3, 2-1 to 2-3

### Comparative Examples 1-1 to 1-5, 2-1 to 2-3, 3-1 to 3-3

The sintered magnet of Examples 1-2, 1-3, 2-1 to 2-3 and Comparative Examples 1-1 to 1-5, 2-1 to 2-3, and 3-1 to 3-3 were each produced in the same manner as in Example 1-1 except for the following matters.

In each example, T2, t2, T3, and t3 were values shown in the following Table 1. T2 and t2 of each Comparative Example except Comparative Examples 3-1 to 3-3 were values shown in the following Table 1. In the aging treatment step of each of Comparative Examples 3-1 to 3-3, the second aging treatment was not performed and the third aging treatment was performed subsequent to the first aging treatment. T3 and t3 of each Comparative Example except for Comparative Example 2-1 were values shown in the following Table 1. In the aging treatment step of Comparative Example 2-1, the third aging treatment was not performed.

Magnetic properties of the sintered magnets of other Examples and Comparative Examples were measured in the same manner as in Example 1-1. The results of measuring the magnetic properties are shown in the following Table 1. It is preferable that Br at 23° C. is 13.5 kG or more, HcJ at 23° C. is 22.5 kOe or more, and HcJ at 150° C. is 7.8 kOe or more.

The cross sections of the sintered magnets of other Examples and Comparative Examples were each analyzed in the same manner as in Example 1-1. The results of analyzing the cross sections of the respective sintered magnets are shown in the following Table 1. It was confirmed that the sintered magnets of Examples 1-2, 1-3, and 2-1 to 2-3 had each the above-described characteristics regarding the main phase grains and the grain boundary multiple junctions in the same manner as Example 1-1. It was confirmed in all the Examples that the following Formulas 1 and 2 are satisfied.

0.30≤N1/(N1+N2+N3)≤0.60 (1)

0.03≤N3/N2≤0.20 (2)

The sintered magnets of each Comparative Examples except for Comparative Examples 1-4, 1-5, 2-1, and 2-2 had the transition metal rich phase, the Cu-poor phase, and the Cu-rich phase as the grain boundary multiple junctions. In the cross sections of the sintered magnets of Comparative Examples 2-1 and 2-2, the transition metal rich phase and the Cu-poor phase were detected, but the Cu-rich phase was not detected. There were no Comparative Examples satisfying both of the above Formulas 1 and 2.

TABLE 1

| | T2 | t2 | T3 | t3 | N1/(N1 + N2 + N3) | N3/N2 | Br @ 23° C. | HcJ @ 23° C. | HcJ @ 150° C. |
|---|---|---|---|---|---|---|---|---|---|
| Unit | ° C. | Minutes | ° C. | Minutes | — | — | kG | kOe | kOe |
| Comparative Example 1-1 | 470 | 60 | 450 | 180 | 0.25 | 0.04 | 13.82 | 18.32 | 6.71 |
| Example 1-1 | 510 | 60 | 450 | 180 | 0.35 | 0.1 | 13.75 | 23.10 | 8.40 |
| Example 1-2 | 530 | 60 | 450 | 180 | 0.45 | 0.11 | 13.63 | 23.06 | 8.36 |
| Example 1-3 | 590 | 60 | 450 | 180 | 0.55 | 0.12 | 13.57 | 22.70 | 8.20 |
| Comparative Example 1-2 | 610 | 60 | 450 | 180 | 0.65 | 0.18 | 13.33 | 22.11 | 7.93 |
| Comparative Example 1-4 | 530 | 60 | 450 | 90 | 0.35 | 0 | 13.83 | 23.12 | 6.97 |
| Comparative Example 1-5 | 530 | 60 | 450 | 120 | 0.36 | 0 | 13.82 | 23.07 | 6.96 |
| Comparative Example 1-3 | 530 | 60 | 450 | 150 | 0.45 | 0.02 | 13.80 | 23.02 | 7.23 |
| Comparative Example 2-1 | 530 | 60 | None | None | 0.35 | 0 | 13.83 | 23.10 | 6.96 |
| Comparative Example 2-2 | 530 | 60 | 400 | 180 | 0.36 | 0 | 13.82 | 23.05 | 6.95 |
| Example 2-1 | 530 | 60 | 420 | 180 | 0.45 | 0.04 | 13.80 | 23.02 | 7.82 |
| Example 2-2 | 530 | 60 | 450 | 180 | 0.48 | 0.1 | 13.76 | 22.78 | 8.31 |
| Example 2-3 | 530 | 60 | 480 | 180 | 0.5 | 0.18 | 13.69 | 22.50 | 8.21 |
| Comparative Example 2-3 | 530 | 60 | 500 | 180 | 0.55 | 0.21 | 13.63 | 19.53 | 7.13 |
| Comparative Example 3-1 | None | None | 450 | 180 | 0.2 | 0.04 | 13.83 | 20.80 | 7.59 |
| Comparative Example 3-2 | None | None | 470 | 180 | 0.24 | 0.08 | 13.82 | 21 | 7.93 |
| Comparative Example 3-3 | None | None | 490 | 180 | 0.28 | 0.1 | 13.80 | 21.25 | 7.76 |

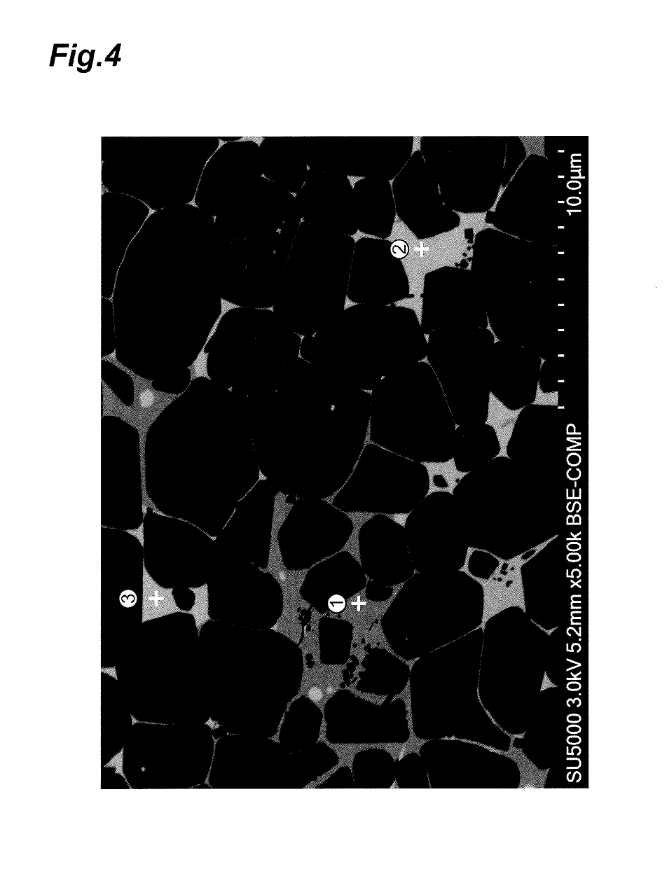

An image of the cross section of the sintered magnet of Example 2-3 taken by the SEM is shown in FIG. 4. The concentrations (unit: atom %) of the respective elements at each of the grain boundary multiple junctions 1, 2, and 3 shown in FIG. 4 are shown in the following Table 2. The concentration of each element is a value based on the point analysis by the EDS as described above. Black portions in FIG. 4 are the main phase grains.

TABLE 2

| | O | Al | Fe | Co | Cu | Ga | R | Total | ([Fe] + [Co])/[R] | [O]/R] | [Cu]/[R] |
|---|---|---|---|---|---|---|---|---|---|---|---|
| | Unit | | | | | | | | | | |
| | Atom | Atom | Atom | Atom | Atom | Atom | Atom | Atom | | | |
| | % | % | % | % | % | % | % | % | — | — | — |
| Grain boundary multiple junction 1 | 4.63 | 1.79 | 56.81 | 2.35 | 0.46 | 4.94 | 29.01 | 100.00 | 2.04 | 0.16 | 0.02 |
| Grain boundary multiple junction 1A | 3.88 | 1.69 | 56.98 | 2.78 | 0.53 | 5.27 | 28.87 | 100.00 | 2.07 | 0.13 | 0.02 |
| Grain boundary multiple junction 1B | 3.74 | 1.35 | 58.38 | 2.14 | 0.49 | 5.39 | 28.51 | 100.00 | 2.12 | 0.13 | 0.02 |
| Grain boundary multiple junction 1C | 3.60 | 1.90 | 57.17 | 2.49 | 0.32 | 5.14 | 29.38 | 100.00 | 2.03 | 0.12 | 0.01 |
| Grain boundary multiple junction 1D | 4.66 | 2.06 | 57.27 | 2.70 | 0.51 | 4.70 | 28.09 | 100.00 | 2.13 | 0.17 | 0.02 |
| Grain boundary multiple junction 1E | 4.08 | 2.23 | 57.74 | 3.24 | 0.28 | 4.84 | 27.59 | 100.00 | 2.21 | 0.15 | 0.01 |
| Grain boundary multiple junction 2 | 3.83 | 0.32 | 30.40 | 0.79 | 13.49 | 4.54 | 46.62 | 100.00 | 0.67 | 0.08 | 0.29 |
| Grain boundary multiple junction 2A | 4.87 | 0.31 | 31.70 | 0.48 | 14.08 | 4.13 | 44.42 | 100.00 | 0.72 | 0.11 | 0.32 |
| Grain boundary multiple junction 2B | 8.51 | 0.38 | 29.42 | 0.55 | 14.42 | 3.88 | 42.84 | 100.00 | 0.70 | 0.20 | 0.34 |
| Grain boundary multiple junction 2C | 3.64 | 0.00 | 38.10 | 0.66 | 15.28 | 4.09 | 38.23 | 100.00 | 1.01 | 0.10 | 0.40 |
| Grain boundary multiple junction 2D | 4.03 | 0.21 | 31.27 | 0.00 | 21.93 | 4.62 | 37.95 | 100.00 | 0.82 | 0.11 | 0.58 |
| Grain boundary multiple junction 2E | 3.94 | 0.50 | 36.26 | 0.44 | 14.57 | 3.74 | 40.55 | 100.00 | 0.91 | 0.10 | 0.36 |
| Grain boundary multiple junction 3 | 5.29 | 0.40 | 28.26 | 1.62 | 6.45 | 12.28 | 45.69 | 100.00 | 0.65 | 0.12 | 0.14 |
| Grain boundary multiple junction 3A | 5.51 | 0.49 | 20.18 | 1.70 | 7.35 | 13.46 | 51.32 | 100.00 | 0.43 | 0.11 | 0.14 |
| Grain boundary multiple junction 3B | 5.26 | 0.33 | 34.55 | 1.58 | 6.08 | 11.09 | 41.12 | 100.00 | 0.88 | 0.13 | 0.15 |
| Grain boundary multiple junction 3C | 4.98 | 0.42 | 12.99 | 2.63 | 7.93 | 14.06 | 56.98 | 100.00 | 0.27 | 0.09 | 0.14 |
| Grain boundary multiple junction 3D | 4.63 | 0.32 | 36.38 | 2.74 | 3.89 | 6.89 | 45.15 | 100.00 | 0.87 | 0.10 | 0.09 |
| Grain boundary multiple junction 3E | 4.05 | 0.33 | 43.18 | 1.31 | 5.09 | 5.88 | 40.17 | 100.00 | 1.11 | 0.10 | 0.13 |

As shown in Table 2, it was confirmed that a grain boundary multiple junction 1 is the transition metal rich phase satisfying the above Formula T1. The compositions of each of the grain boundary multiple junctions 1A to 1E which are found at the same contrast as the grain boundary multiple junction 1 in the SEM image was measured by the EDS. The measurement results are shown in Table 2. It was confirmed that the grain boundary multiple junctions 1A to 1E are the transition metal rich phases satisfying the above Formula T1. It was confirmed that the grain boundary multiple junction 2 is the Cu-rich phase satisfying the above Formulas R1, R2, and C2. The compositions of each of the grain boundary multiple junctions 2A to 2E which are found at the same contrast as the grain boundary multiple junction 2 in the SEM image was measured by the EDS. The measurement results by the EDS are shown in Table 2. It was confirmed that the grain boundary multiple junctions 2A to 2E are the Cu-rich phase satisfying the above Formulas R1, R2, and C2. It was confirmed that the grain boundary multiple junction 3 is the Cu-poor phase satisfying the above Formulas R1, R2, and C1. The compositions of each of the grain boundary multiple junctions 3A to 3E which are found at the same contrast as the grain boundary multiple junction 3 in the SEM image was measured by the EDS. The measurement results are shown in Table 2. It was confirmed that the grain boundary multiple junctions 3A to 3E are the Cu-poor phase satisfying the above Formulas R1, R2, and C1. As shown in FIG. 4, it was confirmed that the transition metal rich phase continuous to the grain boundary multiple junction 1 was formed at a part of the two-grain boundary. In addition, it was confirmed that the Cu-rich phase continuous to the grain boundary multiple junction 2 was formed at a part of the two-grain boundary. In addition, it was confirmed that the Cu-poor phase continuous to the grain boundary multiple junction 3 was formed at a part of the two-grain boundary.

### INDUSTRIAL APPLICABILITY

Since the R-T-B-based sintered magnet according to the present invention is excellent in the magnetic properties, the R-T-B-based sintered magnet can be applied to, for example, a motor mounted on a hybrid vehicle or an electric vehicle.

### REFERENCE SIGNS LIST

2: R-T-B-based sintered magnet, 2cs: Cross section of R-T-B-based sintered magnet, 4: Main phase grain, 6: Transition metal rich phase, 8: R-rich phase, 8A: Cu-poor phase, 8B: Cu-rich phase

What is claimed is:

1. An R-T-B-based sintered magnet comprising:
a rare earth element R, a transition metal element T, B, Cu, and Ga,
wherein the R-T-B-based sintered magnet contains at least one of Nd and Pr as R,
the R-T-B-based sintered magnet contains at least Fe of Fe and Co as T,
the R-T-B-based sintered magnet includes
a plurality of main phase grains including a crystal of R₂T₁₄B, and
a plurality of grain boundary multiple junctions which are grain boundary phases surrounded by at least three of the main phase grains,
the plurality of grain boundary multiple junctions are classified into at least two phases of a transition metal rich phase and an R-rich phase,
the R-rich phase is classified into at least two phases of a Cu-poor phase and a Cu-rich phase,
the transition metal rich phase contains R, T, and Ga, and is a phase satisfying the following Formula T1,
the R-rich phase is a phase satisfying the following Formulas R1 and R2,
the Cu-poor phase is a phase satisfying the following Formula C1,
the Cu-rich phase is a phase satisfying the following Formula C2,
the transition metal rich phase, the Cu-poor phase, and the Cu-rich phase satisfy the following Formula 1, and
the Cu-poor phase and the Cu-rich phase satisfy the following Formula 2.
1.50≤([Fe]+[Co])/[R]≤3.00 (T1)
0.00≤([Fe]+[Co])/[R]<1.50 (R1)
0.00≤[O]/[R]<0.35 (R2)
0.00≤[Cu]/[R]<0.25 (C1)
0.25≤[Cu]/[R]≤1.00 (C2)
[[Fe] in the above Formula T1 and the Formula R1 is a concentration of Fe at the grain boundary multiple junction, [Co] in the above Formula T1 and the above Formula R1 is a concentration of Co at the grain boundary multiple junction, [R] in the above Formula T1, the above Formula R1, the above Formula R2, the above Formula C1, and the above Formula C2 is a concentration of R at the grain boundary multiple junction, [O] in the above Formula R2 is a concentration of O at the grain boundary multiple junction, [Cu] in the above Formula C1 and the above Formula C2 is a concentration of Cu at the grain boundary multiple junction, and units of [Fe], [Co], [R], [O], and [Cu] are each atom %.]
0.30≤N1/(N1+N2+N3)≤0.60 (1)
0.03≤N3/N2≤0.20 (2)
[N1 in the above Formula 1 is the number of transition metal rich phases of the plurality of grain boundary multiple junctions on a cross section of the R-T-B-based sintered magnet, and N2 in the above Formulas 1 and 2 is the number of Cu-poor phases of the plurality of grain boundary multiple junctions on the cross section of the R-T-B-based sintered magnet, and N3 in the above Formulas 1 and 2 is the number of Cu-rich phases of the plurality of grain boundary multiple junctions on the cross section of the R-T-B-based sintered magnet.]

2. The R-T-B-based sintered magnet according to claim 1, comprising:
a plurality of two-grain boundaries which are grain boundary phases positioned between the two adjacent main phase grains,
wherein at least a part of the two-grain boundaries includes at least one of the transition metal rich phase and the R-rich phase.

3. The R-T-B-based sintered magnet according to claim 1, consisting of the following elements:
29.50 to 33.00 mass % of R;
0.70 to 0.95 mass % of B;
0.03 to 0.60 mass % of Al;
0.01 to 1.50 mass % of Cu;
0.00 to 3.00 mass % of Co;
0.10 to 1.00 mass % of Ga;
0.05 to 0.30 mass % of C;
0.03 to 0.40 mass % of O; and
a balance,
wherein the balance is Fe alone or Fe and other elements.

4. The R-T-B-based sintered magnet according to claim 1, wherein a total content of heavy rare earth elements is 0.00 mass % or more and 1.00 mass % or less.
